(19) United States
(12) Patent Application Publication
(10) Pub. No.: US 2023/0138818 A1
(43) Pub. Date: May 4, 2023

(54) CONTAINER ACCESSORY

(71) Applicants: Kressa J. Peterson, Woodstock, GA (US); Anthony M. Peterson, Woodstock, GA (US)

(72) Inventors: Kressa J. Peterson, Woodstock, GA (US); Anthony M. Peterson, Woodstock, GA (US)

(21) Appl. No.: 17/981,004

(22) Filed: Nov. 4, 2022

Related U.S. Application Data
(60) Provisional application No. 63/275,769, filed on Nov. 4, 2021.

(51) Int. Cl. B65D 47/18; B65D 47/32

(52) U.S. Cl. CPC B65D 47/185; B65D 47/32

(57) ABSTRACT

A container accessory for dispensing fluid from a container comprises a first container attachment, a body, a dispensing head, and a second container attachment. The container accessory has a fluid pathway from the first container attachment through the body to the dispensing head. Upon attaching an outlet of a container to the first container attachment, fluid may flow by gravity from the container through the fluid pathway and be dispensed by the dispensing head. Upon attaching an outlet of a container to the second attachment, fluid is prevented from flowing through the fluid pathway and is maintained within the container. Therefore, during delivery and storage of a container, the container accessory may be attached to the second attachment to prevent spilling fluid from the container.

### BACKGROUND

Various container accessories are removably attached to a container to allow for dispensing of fluids from container. Some portable shower accessories may attach to a bottle and dispense fluids, such as water, from the bottle. However, such portable shower accessories either don't have a vent, leading to irregular dispensing rates and requiring physical manipulation (e.g., squeezing) the bottle, or have long vent tubes that are detachable and easily lost or damaged. Additionally, prior portable shower accessories are unable to sealingly engage with the bottle for storage and transportation of the bottle without dispensing the fluid contained therein.

### SUMMARY

An aspect of the disclosure includes a container accessory comprising a first container attachment, a dispensing head, a body with a fluid pathway extending from the first container attachment to the dispensing head, and a second container attachment attached to the body and comprising a lid.

In some implementations of the first aspect of the disclosure, the second container attachment is positioned on the body between the first container attachment and the dispensing head.

In some implementations of the first aspect of the disclosure, the first container attachment and the second container attachment are threaded collars.

In some implementations of the first aspect of the disclosure, the dispensing head comprises a plurality of dispensing holes.

In some implementations of the first aspect of the disclosure, the dispensing head further comprises a vent opening.

In some implementations of the first aspect of the disclosure, the container accessory further comprises a vent tube attached at a first end to the vent opening and extending through the body and the first container attachment.

In some implementations of the first aspect of the disclosure, the vent tube comprises a check valve on a second end of the vent tube opposite to the first end, the check valve is oriented to allow fluid flow from the vent opening to the second end of the vent tube.

In some implementations of the first aspect of the disclosure, a diameter of the dispensing head is greater than a diameter of the body.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a container accessory attached to a bottle in a dispensing configuration according to various embodiments of the disclosure.

FIG. 2 illustrates the container accessory of FIG. 1 dispensing fluid from the bottle according to various embodiments of the disclosure.

FIG. 3 illustrates the container accessory of FIG. 1 releasably attached to the bottle according to various embodiments of the disclosure.

FIG. 4 illustrates the container accessory in a stowed configuration according to various embodiments of the disclosure.

FIG. 5 illustrates the container accessory of FIG. 4 being transported by a handle according to various embodiments of the disclosure.

FIG. 6 is a first perspective view of a container accessory according to various embodiments of the disclosure.

FIG. 7 is a second perspective viewof a container accessory according to various embodiments of the disclosure.

### DETAILED DESCRIPTION

The following description of certain examples of the inventive concepts should not be used to limit the scope of the claims. Other examples, features, aspects, embodiments, and advantages will become apparent to those skilled in the art from the following description. As will be realized, the device and/or methods are capable of other different and obvious aspects, all without departing from the spirit of the inventive concepts. Accordingly, the drawings and descriptions should be regarded as illustrative in nature and not restrictive.

For purposes of this description, certain aspects, advantages, and novel features of the aspects of this disclosure are described herein, The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Features, integers, characteristics, compounds, chemical moieties, or groups described in conjunction with a particular aspect or example of the present disclosure are to be understood to be applicable to any other aspect or example described herein unless incompatible therewith. All of the features disclosed in this specification (including any accompanying claims, abstract, and drawings), and/or all of the steps of any method or process so disclosed, may be combined in any combination, except combinations where at least some of such features and/or steps are mutually exclusive. The present disclosure is not restricted to the details of any foregoing aspects. The present disclosure extends to any novel one, or any novel combination, of the features disclosed in this specification (including any accompanying claims, abstract, and drawings), or to any novel one, or any novel combination, of the steps of any method or process so disclosed.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

As used in this application and in the claims, the singular forms “a,” “a” and “the” include the plural forms unless the context dearly dictates otherwise. Additionally, the term “includes” means “comprises.” Further, the terms “coupled” and “associated” generally means electrically, electromagnetically, and/or physically (e.g., mechanically or chemically) coupled or linked and does not exclude the presence of intermediate elements between the coupled or associated items.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

Use of the phrase “and/or” indicates that any one or any combination of a list of options can be used. For example, “A, B, and/or C” means “A”, or “B”, or “C”, or “A and B”, or “A and C” or “B and C”, or “A and B and C”.

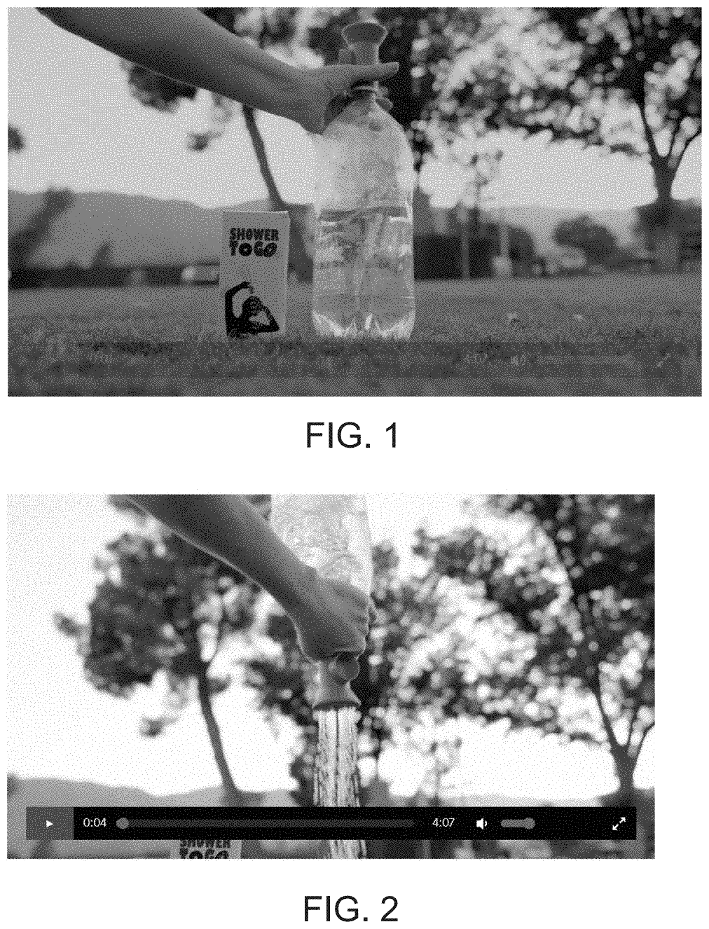

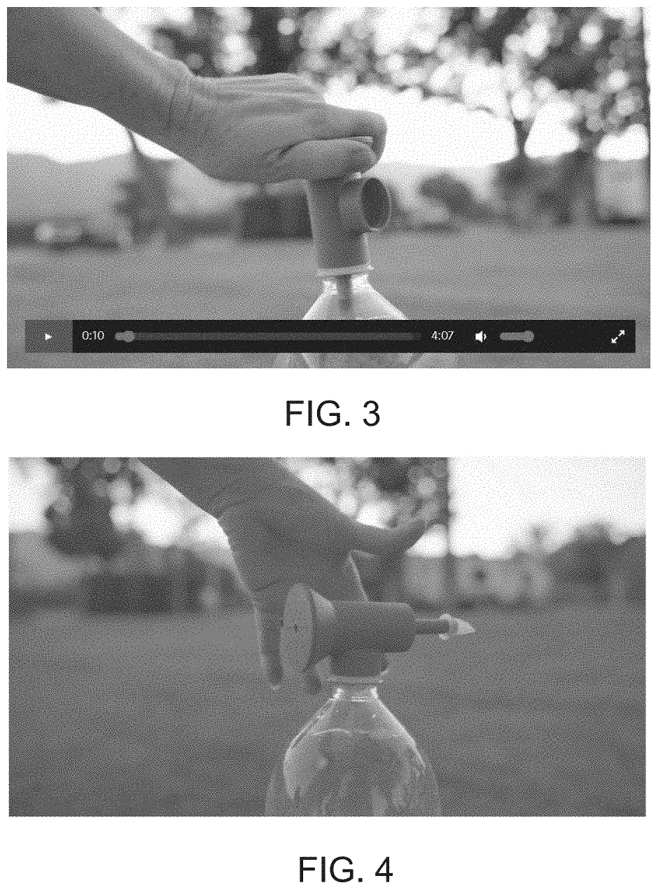

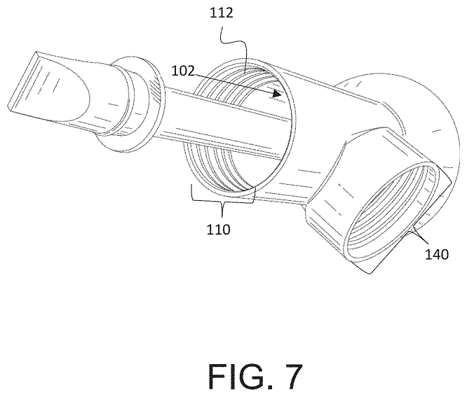

FIGS. 1-7 illustrate various view of a container accessory 100. The container accessory 100 disclosed herein facilitates even dispensing of fluid from a container. The container accessory comprises 100 a first container attachment 110, a body 120, a dispensing head 130 (valveless dispensing head), and a second container attachment 140. The container accessory 100 has a fluid pathway 102 from the first container attachment 110 through the body 120 to the dispensing head 130. Upon attaching an outlet of a container to the first container attachment 110, fluid may flow by gravity from the container through the fluid pathway 102 and be dispensed by the dispensing head 130 (e.g., FIGS. 1-2). Upon attaching an outlet of a container to the second attachment 140, fluid is prevented from flowing through the fluid pathway 102 and is maintained within the container. Therefore, during delivery and storage of a container, the container accessory 100 may be attached to the second attachment 140 to prevent spilling fluid from the container.

The first container attachment 110 comprises threads 112 for releasably attaching the container accessor 100 to a container. For example, the threads 112 may engage with a threaded mouth of a container outlet for sealingly attaching the container accessory 100 to the container. In the example shown, the first container attachment 110 is integrally formed with the body 120. That is, the threads 112 may be formed in the straight walled tube of the body 120. Other configurations are contemplated by this disclosure.

In the example show, the body 120 is a straight walled tube with a same diameter as the first container attachment 110. In some implementations, the body may have a smaller or larger diameter as the first container attachment 110. In some embodiments, the body 120 may have a circuitous or otherwise non-linear path. Other modifications to the body 120 are contemplated by this disclosure.

The dispensing head 130 (sometimes referred to as a valveless dispensing nozzle) comprises a dispensing body 132 and a dispensing plate 134 (sometimes referred to as a diffuser plate). In the example shown, the dispensing plate 134 has a larger diameter than the body 120. In other examples, the diameter of the dispensing plate 134 may be the same size as or smaller that the diameter of the body 120. The dispensing body 132 is a tapered surface extending between the body 120 and the dispensing plate 134 with a gradually increasing diameter therebetween. At the connection with the body 120, the tapered surface of the dispensing body 132 has a same diameter as the body 120. At the connection with the dispensing plate 134, the tapered surface of the dispensing body 132 has a same diameter as the dispensing plate 134. In embodiments where the dispensing plate 134 is the same diameter as the body 120, the dispensing body 132 may be omitted or be formed as a straight walled tube.

The dispensing plate 134 comprises a plurality of dispensing holes 136 and a vent opening 154. The dispensing holes 136 extend through the dispensing plate 134 for dispensing fluid from the dispensing head 130. The dispensing holes 136 may be arranged in any regular or irregular pattern on the dispensing plate 134. In the example show, the dispensing holes 136 are arranged in linear arrays extending from a center of the dispensing plate 134, with each linear array spaced apart radially around the dispensing plate 134. In the example shown, each of the linear arrays comprises four dispensing holes 136 and is spaced apart from other linear arrays by 45°. Other numbers of dispensing holes 136, radial spacing, or arrangement of dispensing holes are contemplated by this disclosure.

A vent tube 150 is attached to the vent opening 154 in the dispensing plate 134. The vent opening 154 in combination with the vent tube 150 promote venting air into an attached container while dispensing fluid to equalize pressure internal and external to the container and promote a constant flow rate. The vent tube 150 includes a check valve 152 to prevent fluid flow from the container through the vent tube 150. In other words, the check valve is oriented to allow fluid flow from the vent opening 154 through the vent tube 150 and prevent fluid flow from the vent tube 150 though the vent opening 154. In the example shown, the check valve is a duckbill valve, though other check valves are contemplated by this disclosure. In the example shown, the vent opening 154 is in a center of the dispensing plate 134, though other placements of the vent opening 154 anywhere on the dispensing plate 134 are contemplated.

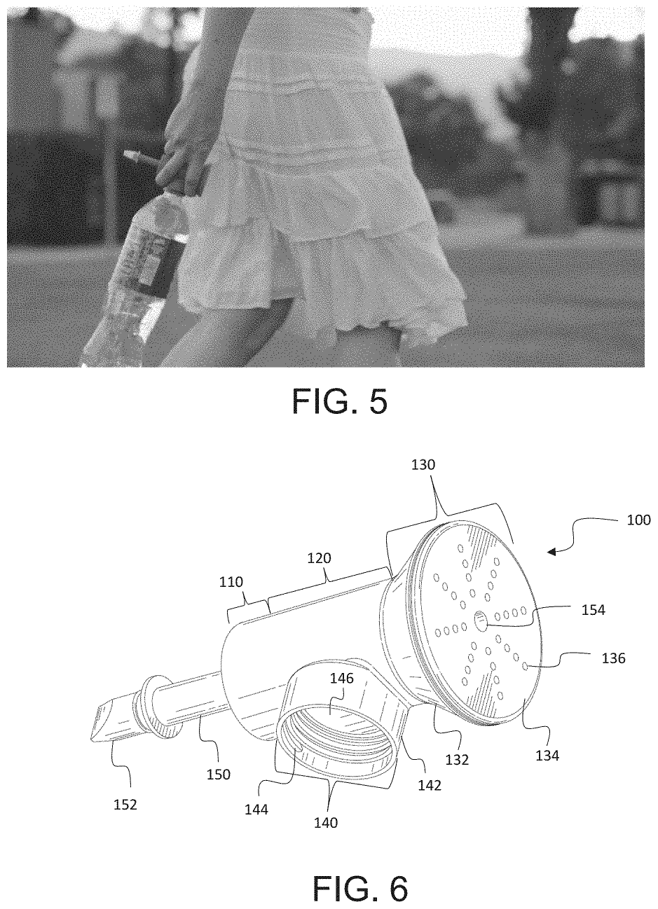

The second container attachment 140 is affixed to the body 120 of the container accessory 100. In the example shown, the second container attachment 140 is orthogonal to the first container attachment 110. The second container attachment 140 is positioned at a mid-point along the body 120 so as to form a handle for carrying the container accessory 100 when attached to a container in a stowed configuration (e.g., FIGS. 4-5).

The second container attachment 140 comprises a collar 142 sized and shaped to engage with a mouth of a container. In the example shown, the collar 142 comprises threads 144 for engaging with a threaded mouth of a container outlet for sealingly attaching the container accessory 100 to the container. A lid 146 of the collar 142 provides a closed (sealed) surface to prevent liquid from escaping from a container when attached to the container accessory 100. In some implementations, the lid 146 is formed by the body 120. In some implementations, the lid 146 is a flat surface affixed to the body 120 so as to provide a flat sealing surface for attachment to a mouth of a container. In use, the second container attachment 140 may be releasably attached to a container in a stowed configuration of the container accessory 100 for transport and carrying of a container with fluid so as to prevent spilling the fluid from the container.

In the example shown, the first and second container attachments 110, 140 are threaded collars for engaging with a threaded mouth of a container (e.g., beverage container, such as a 2-liter bottle). Other connectors for attaching the container accessory 100 to a container are contemplated by this disclosure, including snap connectors for releasably attaching to neck ring of container, frictional connectors for frictional engagement with the mouth of container, tapered conical connectors for frictional fit with container opening (e.g., bottle stopper), or any other mechanism known by those skilled in the art for attaching an accessory to a container.

While the container is shown and described as a threaded container in various examples above (e.g., 2-liter plastic bottle), other types of containers are contemplated by this disclosure (e.g., milk jug, glass jar, etc.).

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A container accessory, comprising:
a first container attachment;
a dispensing head;
a body with a fluid pathway extending from the first container attachment to the dispensing head; and
a second container attachment attached to the body and comprising a lid.

2. The container accessory of claim wherein the second container attachment is positioned on the body between the first container attachment and the dispensing head.

3. The container accessory of claim 1, wherein the first container attachment and the second container attachment are threaded collars.

4. The container accessory of claim 1, wherein the dispensing head comprises a plurality of dispensing holes.

5. The container accessory of claim 4, wherein the dispensing head further comprises a vent opening.

6. The container accessory of claim 5, further comprising:
a vent tube attached at a first end to the vent opening and extending through the body and the first container attachment.

7. The container accessory of claim 6, wherein the vent tube comprises a check valve on a second end of the vent tube opposite to the first end, the check valve is oriented to allow fluid flow from the vent opening to the second end of the vent tube.

8. The container accessory of claim 1, wherein a diameter of the dispensing head is greater than a diameter of the body.
